(19) United States
(12) Patent Application Publication
(10) Pub. No.: US 2012/0086993 A1
(43) Pub. Date: Apr. 12, 2012

(54) PHOTOPOLYMER MEDIUM FOR COLOR HOLOGRAM IMAGE RECORDING AND COLOR HOLOGRAM IMAGE RECORDING METHOD

(75) Inventors: Naoki HAYASHIDA, Tokyo (JP); Kazushi TANAKA, Tokyo (JP); Jiro YOSHINARI, Tokyo (JP)

(73) Assignee: TDK CORPORATION, Tokyo (JP)

(21) Appl. No.: 13/226,119

(22) Filed: Sep. 6, 2011

(30) Foreign Application Priority Data
Oct. 7, 2010 (JP) 2010-227468

(51) Int. Cl. G03H 1/02; G03H 1/26

(52) U.S. Cl. 359/3; 359/22

(57) ABSTRACT

A photopolymer medium 10 for color hologram image recording, which is formed so that a color image having a high diffraction efficiency can be obtained by exposing the same recording layer to light at a plurality of wavelengths, includes a recording layer 14 that has a recording sensitivity to light in two wavelength regions of a wavelength λ₁ and a wavelength λ₂. This recording layer 14 is formed from a material in which a transmittance T₁ of light at the wavelength λ₁ and a transmittance T₂ of light at the wavelength λ₂ of the recording layer before recording are both less than 80%, T₁<T₂ is satisfied, a transmittance T_{1after} of light at the wavelength λ₁ after recording has been performed with light at only the wavelength λ₂ satisfies T_{1after}>T₁, and 10%<T_{1after}<80%.

### BACKGROUND OF THE INVENTION

1. Field of the Invention

The present invention relates to a photopolymer medium for color hologram image recording capable of recording a color image and a color hologram image recording method for recording a color image using this photopolymer medium.

2. Description of the Related Art

Ideally, a recording medium for recording a color hologram image should be able to record red, green, and blue images, for example, on a single photosensitive layer.

However, a vivid reproduced image cannot be obtained when two or more interference fringes are simultaneously exposed on a single photosensitive layer.

Especially, when a photopolymerizable photopolymer is used as the photosensitive layer, if the interference fringes from each of the individual colors are sequentially exposed, the viscosity of the photopolymer increases due to the recording of the first color, so that the sensitivity of the photopolymer deteriorates for the recording of the second and subsequent colors. Consequently, it becomes essentially impossible to record the interference fringe for third color.

A photosensitive layer could be provided for each color while separating the photosensitive layers with an isolation layer, and exposure for each color is carried out. However, such a technique would increase production costs.

In view of this problem, Japanese Patent Application Laid-Open No. Hei. 5-273900 proposes a laminated body for a color hologram having a first photosensitive layer formed from a photosensitive composition that is photosensitive to red and green, a second photosensitive layer formed from a photosensitive composition that is photosensitive to blue, and an isolation layer that separates the two photosensitive layers from each other.

Japanese Patent Application Laid-Open No. Hei. 5-273900 discloses that when recording a three-color image on the laminated body for a color hologram with the above configuration, it is preferred to sequentially record red, then green, and then blue. More specifically, when recording the interference fringes, it is preferred to sequentially record the interference fringes by changing from recording light having a long wavelength to recording light having a short wavelength. This is done in order to prevent a deterioration in the diffraction efficiency of the red interference fringe due to the green interference fringe also being recorded in the red photosensitive layer when the recording is carried out in the reverse order from that described above or is carried out simultaneously, for example.

However, although the color hologram laminated body of the invention described in Japanese Patent Application Laid-Open No. Hei. 5-273900 obtains a high diffraction efficiency when special recording materials are used, since no consideration is given to the appropriate transmittance in the recording layer for the light with each wavelength, it is not always possible to obtain a high diffraction efficiency.

### SUMMARY OF THE INVENTION

In view of the foregoing problems, various exemplary embodiments of this invention provide a photopolymer medium for color hologram image recording (hereinafter, “photopolymer medium”), and a method for recording a color hologram, in which when performing exposure with light at a plurality of wavelengths, before a target recording layer is exposed, the target recording layer has an appropriate transmittance to light at the corresponding wavelength, thereby enabling a color image that has a high diffraction efficiency to be obtained.

In summary, the above-described objectives are achieved by the following embodiments of the present invention.

(1) A photopolymer medium for color hologram image recording, comprising a recording layer which comprises at least a photopolymerizable monomer, a photopolymerization initiator, and a sensitizing dye, and which has a recording sensitivity to light in two wavelength regions of a wavelength λ₁ and a wavelength λ₂, in which λ₂−λ₁≧20 nm is satisfied, wherein the recording layer is formed from a material in which, when a transmittance T₁ of light at the wavelength λ₁ and a transmittance T₂ of light at the wavelength λ₂ of the recording layer before recording are both less than 80% and T₁≠T₂ is satisfied, a transmittance T_{after} of light at the wavelength λ₂ or λ₁ after recording has been performed with light at only the wavelength λ₁ or λ₂ having a higher transmittance is greater than a lower value from among T₁ and T₂, and the transmittance T_{after} is more than 10% and less than 80%.

(2) The photopolymer medium for color hologram image recording according to (1), wherein the recording layer is formed from a material in which T₁<T₂ is satisfied, a transmittance T_{1after} of light at the wavelength λ₁ after recording has been carried out with only light at the wavelength λ₂ satisfies T_{1after}>T₁, and 10%<T_{1after}<80%.

(3) The photopolymer medium for color hologram image recording according to (2), wherein T₁ and T_{1after} satisfy ΔT₁=(T_{1after}−T₁)/T_{1after}>0.1.

(4) The photopolymer medium for color hologram image recording according to (1), wherein the recording layer is formed from a material in which T₁>T₂ is satisfied, a transmittance T_{2after} of light at the wavelength λ₂ after recording has been carried out with only light at the wavelength λ₁ satisfies T_{2after}>T₇, and 10%<T_{2after}<80%.

(5) The photopolymer medium for color hologram image recording according to (4), wherein T₂ and T_{2after} satisfy ΔT₂=(T_{2after}−T₂)/T_{2after}>0.1.

(6) The photopolymer medium for color hologram image recording according to any one of (1) to (5), wherein λ₁ and λ₂ satisfy 440 nm≦λ₁≦490 nm and 510 nm≦λ₂≦535 nm, respectively.

(7) The photopolymer medium for color hologram image recording according to any one of (1) to (6), wherein, when the wavelength of light having a pre-recording transmittance of Tₘ is λₘ, the recording layer is formed from a material which satisfies λ₁<λₘ<λ₂, Tₘ<T₁, and Tₘ<T₂.

(8) The photopolymer medium for color hologram image recording according to any one of (1) to (7), wherein the recording layer includes one or two recording layers, the sensitizing dye in the one or two recording layers are essentially one type, and when the maximum absorption wavelength of the sensitizing dye in the recording material composition is λₘₐₓ, λ₁<λₘₐₓ<λ₂ is satisfied.

(9) The photopolymer medium for color hologram image recording according to any one of (1) to (8), comprising a second recording layer in addition to the recording layer, the second recording layer having a sensitivity to light at a wavelength λ₃ in which λ₃−λ₂≧20 nm is satisfied.

(10) A method for recording a color hologram image which is formed from a plurality of colors on a photopolymer medium for color hologram image recording, the photopolymer medium comprising at least one recording layer which comprises at least a photopolymerizable monomer, a photopolymerization initiator, and a sensitizing dye, and which has a recording sensitivity to light in two wavelength regions of a wavelength λ₁ and a wavelength λ₂, in which λ₂−λ₁≧20 nm is satisfied, the method comprising: when performing wavelength multiplexed recording using a light source having the wavelength λ₁ and a light source having the wavelength λ₂, respectively, if a transmittance of light at the wavelength λ₁ of the photopolymer medium before recording is T₁ and a transmittance of light at the wavelength λ₂ of the photopolymer medium is T₂, and T₁≠T₂ is satisfied, first performing recording with light at the wavelength λ₁ or λ₂ that has the higher transmittance so that the transmittance of light at λ₂ or λ₁ is greater than 10% and less than 80%, and then performing recording with light at the wavelength λ₂ or λ₁.

(11) The method for recording a color hologram image according to (10), wherein, when T₁<T₂ is satisfied, recording with light at the wavelength λ₂ is performed first so that 10%<T₁<80% is satisfied, and then recording with light at the wavelength λ₁ is performed.

(12) The method for recording a color hologram image according to (10), wherein, when T₁>T₂ is satisfied, recording with light at the wavelength λ₁ is performed first so that 10%<T₂<80% is satisfied, and then recording with light at the wavelength λ₂ is performed.

(13) The method for recording a color hologram image according to (11) or (12), wherein the photopolymer medium comprises a second recording layer in addition to the recording layer formed from one layer, the second recording layer having a sensitivity to light at a wavelength λ₃ in which λ₃−λ₂≧20 nm is satisfied, and wherein recording is performed on the second recording layer with light at the wavelength λ₃ before performing the recording with light at the wavelengths λ₁ and λ₂.

The present invention has the excellent advantageous effect that, when performing exposure with light at a plurality of wavelengths, before the recording layer is exposed, the recording layer has an appropriate (relatively high) transmittance to light at the corresponding wavelength, thereby enabling the diffraction efficiency of the recorded image to be increased.

### BRIEF DESCRIPTION OF THE DRAWINGS

FIG. 1 is a cross sectional diagram schematically illustrating a photopolymer medium according to a first exemplary embodiment of the present invention;

FIG. 2 is an optical system chart illustrating a recording optical system for recording a color image on the photopolymer medium;

FIG. 3 is a line diagram illustrating a pre-recording transmission spectrum of a photopolymer medium according to the first exemplary embodiment of the present invention;

FIG. 4 is a cross sectional diagram schematically illustrating a photopolymer medium according to a second exemplary embodiment of the present invention; and

FIG. 5 is a line diagram illustrating a pre-recording transmission spectrum of a photopolymer medium according to the second exemplary embodiment of the present invention.

### DETAILED DESCRIPTION OF THE PREFERRED EMBODIMENTS

Exemplary embodiments of the present invention will now be described in more detail.

### First Exemplary Embodiment

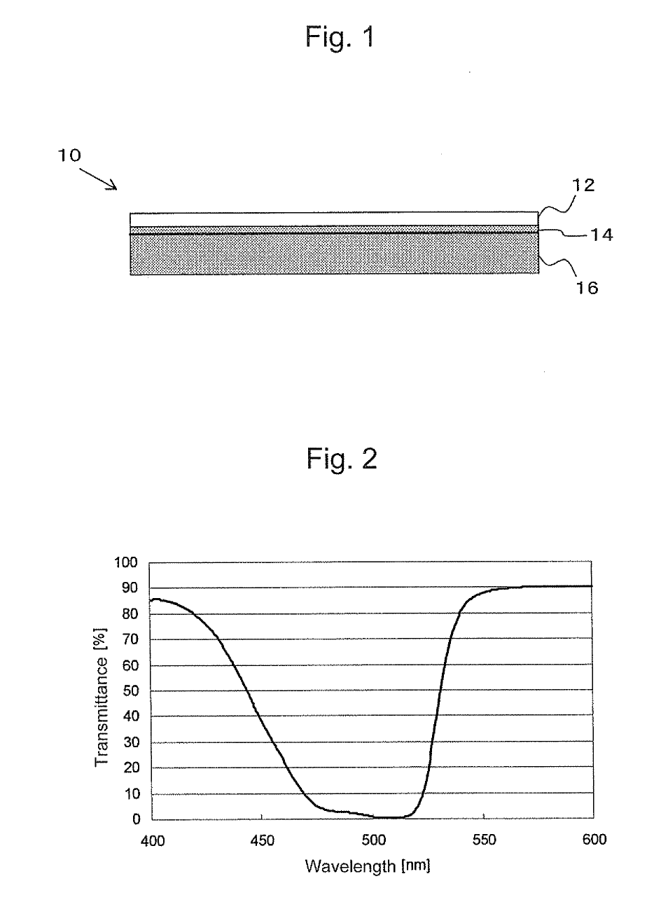

First, a production process of a photopolymer medium 10 for color hologram image recording according to a first exemplary embodiment, which is illustrated in FIG. 1, will be described.

The following composition was mixed according to the following procedure to prepare a recording material composition solution.

Three grams of 9,9-bis[4-(2-acryloyloxyethoxy)phenyl]fluorene (Shin-Nakamura Chemical Co., Ltd., NK Ester A-BPEF) as a photopolymerizable monomer and 1.6 g of diethyl sebacate as a plasticizer were added to 10 g of a vinyl acetate polymer (Wako Pure Chemical Industries, Ltd., Vinyl Acetate Polymer, number average molecular weight=1400-1600, 50% methanol solution) serving as a matrix. To the resultant mixture, 2.4 g of a peroxide photopolymerization initiator (Chisso Corporation, BT-2, a mixture of 3,3′-di(tert-butylperoxycarbonyl)-4,4′-di(methoxycarbonyl)benzophenone and a position isomer in 40% anisole solution) was added.

In addition, 6 g of acetone in which 10 mg of a sensitizing dye (3-butyl-2-[3-(3-butyl-5-phenyl-1,3-benzoxazole-2(3H)-ylidene)propane-1-en-1-yl]-5-phenyl-1,3-benzoxazole-1-ium=hexafluoro-λ5-phosphanuide, Chemical Formula 1) had been dissolved was added, and the mixture was then stirred to dissolve.

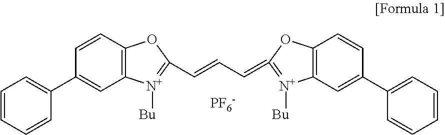

The thus-obtained recording material composition solution was coated on a PET (polyethylene terephthalate) film 12 having a thickness of 100 μm using a bar coater, then dried under reduced pressure for 10 hours at room temperature to produce a recording layer 14. This recording layer 14 was stuck to a slide glass 16 having a thickness of 1.0 mm to form a sample of the photopolymer medium 10. The dried thickness of the film was about 20 μm.

The pre-recording transmission spectrum of the above-produced photopolymer medium 10 was measured using a spectrophotometer (manufactured by JASCO Corporation, V-660). The results are illustrated in FIG. 2.

As shown in Table 1, the transmittance T₁ and T₂ of the recording medium at a blue light wavelength λ₁ of 473 nm and a green light wavelength λ₁ of 532 nm was T₁=6.3% and T₂=53.2%.

TABLE 1

| | Transmittance | | | |
|---|---|---|---|---|
| | | | Rate of | |
| | | | Change ΔT | |
| | Before | 532 nm After | (T_{after} − T)/ | Diffraction |
| | Recording | Exposure | T_{after} | Efficiency |
| λ₁ = 473 nm | T₁ = 6.3% | T_{1after} = 51.3% | ΔT₁ = 87.7% | 87% |
| λ₂ = 532 nm | T₂ = 53.2% | — | — | 83% |

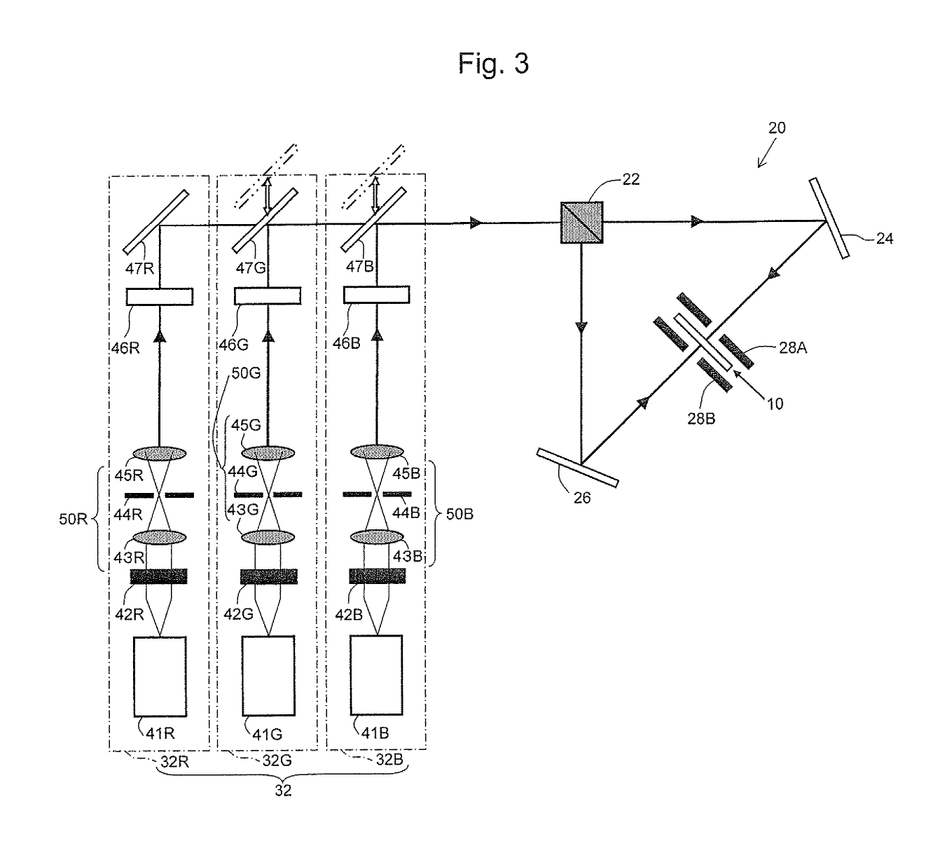

Next, with reference to FIG. 3, a recording optical system 20 for recording a reflective hologram on the photopolymer medium 10 will be described.

This recording optical system 20 is configured to include a beam splitter 22, mirrors 24 and 26, and a laser light source apparatus 32. The laser light source apparatus 32 emits a red, green, or blue laser beam onto the beam splitter 22. The beam splitter 22 separates the incident laser light into two beams of polarized light. The polarized light is reflected by the mirrors 24 and 26, which are located at an optically equal distance from the beam splitter 22, onto the photopolymer medium 10 from opposite directions.

In FIG. 3, reference numerals 28A and 285 denote an aperture located on either side of the photopolymer medium 10.

The laser light source apparatus 32 includes a red laser light source apparatus 32R, a green laser light source apparatus 32G, and a blue laser light source apparatus 325.

The red laser light source apparatus 32R includes a mirror 47R that reflects red laser light from a red laser 41R, which emits red laser light, toward the beam splitter 22. Between the red laser 41R and the mirror 47R are arranged, in order, a shutter 42R, a convex lens 43R, a pinhole 44R, a convex lens 45R, and a half wave plate 46R.

Since the green laser light source apparatus 32G and blue laser light source apparatus 32B have the same configuration as the red laser light source apparatus 32R, these units can be described by replacing the “R” in the reference numerals with “G” or “B”. Therefore, a description thereof will be omitted here.

The shutter 42R and a spatial filter 50R formed from the convex lenses 43R and 45R and the pinhole 44R shape the red laser light emitted from the red laser 41 into a beam profile, so that the beam has an expanded diameter and is collimated, and is incident on the half wave plate 46R.

At the half wave plate 46R, the incident light turns into s-polarized light. This s-polarized light is reflected by the mirror 47R, is incident on the beam splitter 22, and is split into two light beams of transmitted light and reflected light.

The two beams of s-polarized light are reflected by the mirrors 24 and 26, respectively, and narrowed into a predetermined beam diameter by apertures 28A and 285 to form an interference fringe in the photopolymer medium 10. Consequently, a reflective hologram is recorded in the photopolymer medium 10.

When recording an image by irradiating red laser light, the mirrors 47G and 47B in the green and blue laser light source apparatuses 32G and 325 are moved out of the red laser light path between the mirror 47 and the beam splitter 22.

Similarly, when recording a hologram with green laser light or blue laser light, the mirrors on the light path of that laser light are also moved away.

Since the process for exposing the photopolymer medium 10 for color hologram image recording with the green or blue laser light source apparatus 32G or 328 is the same as the exposure with the red laser light source apparatus 32R, a description thereof is omitted here.

Using the recording optical system 20 illustrated in FIG. 3, a reflective hologram was recorded onto the above-produced photopolymer medium 10 by plane waves with the green and blue laser light source apparatuses 32G and 328.

As the green laser 41G, a Nd:YAG laser (wavelength λ₂=532 nm) was used.

The intensity of each of the two light beams when recording was 95 μW/cm² (total 190 μW/cm²). Recording exposure was carried out for 20 μsec at an accumulated light amount of 3.8 mJ/cm².

Subsequently, as shown in Table 1, measurement of the transmission spectrum showed that the transmittance T_{1after} at λ₁=473 nm was 51.3%, which was substantially greater than the pre-recording T₁ of 6.3%. This is because the sensitizing dye in the recording material decomposed with the recording exposure at the wavelength λ₂, so that the absorption due to the dye decreased.

Next, a reflective hologram was recorded by wavelength multiplexing at wavelength λ₁=473 nm with the blue laser 41B at the same position on the photopolymer medium 10.

As the specific blue laser 41B, a Nd:YAG laser (wavelength λ₂=473 nm) was used to record a reflective hologram in the same manner as described above.

The intensity of each of the two light beams when recording was 23 μW/cm² (total 46 WW/cm²). Recording exposure was carried out for 125 μsec at an accumulated light amount of 5.8 mJ/cm².

Subsequently, the photopolymer medium 10 for color hologram image recording was left for several hours under a fluorescent lamp, which caused unreacted components to react and the coloring derived from the sensitizing dye to completely disappear (post curing).

This post-cured photopolymer medium 10 was set in a spectrophotometer (manufactured by JASCO Corporation, V-660), and its transmission spectrum was measured. Based on the peak intensity and peak wavelength, the diffraction efficiency of the reflective hologram was determined. As shown in Table 1, a high diffraction efficiency of 87% at λ₁=473 nm and 83% at λ₂=523 nm could be obtained.

### Second Exemplary Embodiment

Next, in addition to a first recording layer, which is a recording layer for green and blue, the production process of a photopolymer medium for color hologram image recording having a second recording layer, which is a recording layer for red, will be described.

A recording material composition solution was prepared in the same manner as in the first exemplary embodiment, except that a compound represented by Chemical Formula 2 (3-ethyl-2-[5 (3-ethyl-1,3-benzoxazole-2(3H)-ylidene)penta-1,3-dien-1-yl]-1,3-benzoxazole-3-ium=bis(trifluoromethanesulfone)imidate) was used as the sensitizing dye.

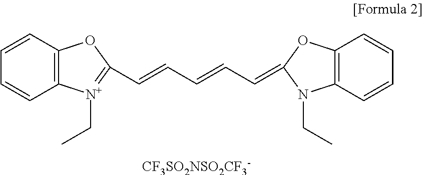

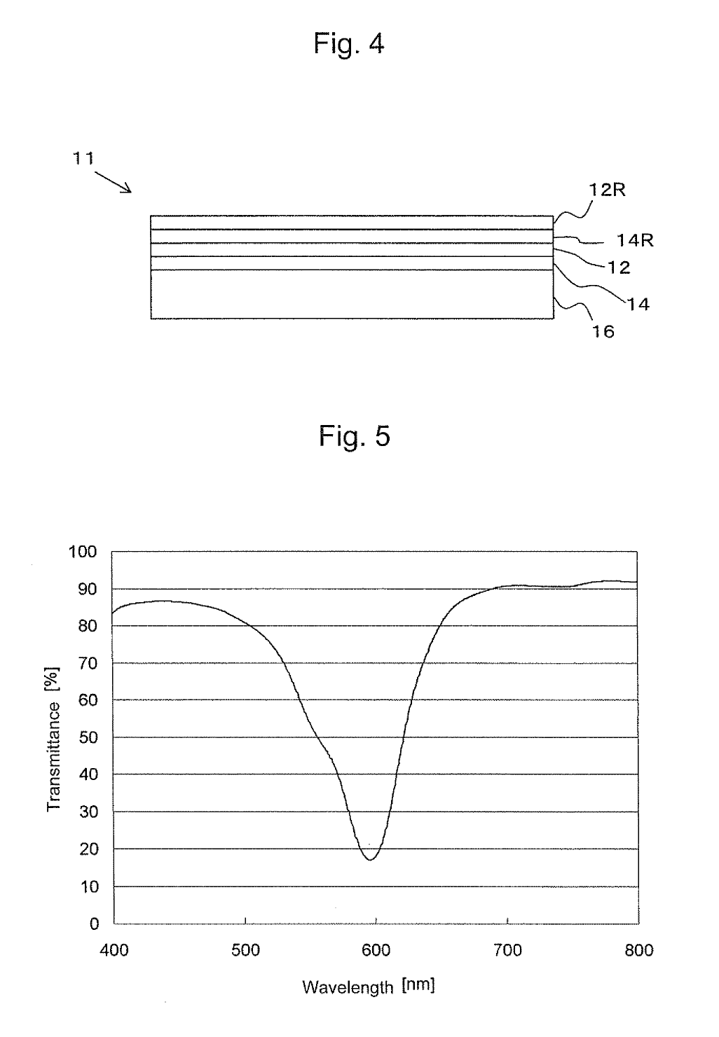

The thus-obtained recording material composition solution was coated on a PET film 12R having a thickness of 100 μm using a bar coater, then dried under reduced pressure for 10 hours at room temperature to produce a second recording layer 14R. This second recording layer 14R was stuck on top of the PET film 12 of the photopolymer medium 10 produced in the first exemplary embodiment, to form a sample of a photopolymer medium 11 having the structure illustrated in FIG. 4. The dried thickness of the recording layer 14R was about 20%.

The transmission spectrum of the above second recording layer 14R (in a state prior to being stuck on the photopolymer medium 11) was measured using a spectrophotometer (manufactured by JASCO Corporation, V-660). The results are illustrated in FIG. 5. As shown in Table 2, the transmittance T₃ at a wavelength λ₃=633 nm was 65.6%.

A reflective hologram was recorded on the photopolymer medium 11 by wavelength multiplexing in the same manner as in the first exemplary embodiment. Before the recording with the green and blue lasers, recording was carried out with the red laser.

As the specific red laser 41R, a He:Ne laser (wavelength λ₃=633 nm) was used. The intensity of each of the two light beams when recording was 8.0 μW/cm² (total 15.9 μW/cm²). Recording exposure was carried out for 2.52 sec at an accumulated light amount of 40.1 mJ/cm².

The transmittances T₁ and T₂ at λ₁=473 nm and λ₂=532 nm after recording with the red laser were measured. As shown in Table 2, these values were T₁=5.9% and T₂=52.5%, respectively, which are roughly the same as the pre-recording values of the photopolymer medium produced in the first exemplary embodiment (see Table 1). More specifically, it was confirmed that there is no effect on the performance of the first recording layer even if a second recording layer is stacked and recording exposure is carried out at the wavelength λ₃=633 nm.

Next, wavelength multiplexed recording was carried out at the wavelength λ₁=473 nm and the wavelength λ₂=532 nm in the same manner as in the first exemplary embodiment. Measurement of the T_{1after} and ΔT₁ showed that these values were about the same as in the first exemplary embodiment. Further, post curing was carried out in the same manner as in the first exemplary embodiment. The diffraction efficiency of the reflective hologram at the wavelengths λ₁, λ₂, and λ₃ was determined, and these results are shown in Table 2. Each diffraction efficiency was between 79 to 82%, meaning that good properties were obtained.

TABLE 2

| | | Transmittance | | | | |
|---|---|---|---|---|---|---|
| | | | 633 nm | 532 nm | | |
| | | Before | After | After | Rate of | Diffraction |
| | | Recording | Exposure | Exposure | Change ΔT | Efficiency |
| First | λ₁ = | — | T₁ = 5.9% | T_{1after} = | ΔT₁ = 88.9% | 82% |
| Recording | 473 nm | | | 53.0% | | |
| Layer | λ₂ = | — | T₂ = 52.5% | — | — | 80% |
| | 532 nm | | | | | |
| Second | λ₃ = | T₃ = 65.6% | — | — | — | 79% |
| Recording | 633 nm | | | | | |
| Layer | | | | | | |

T₃ is a measured value for the second recording layer alone
Comparative Example

A reflective hologram was recorded on the photopolymer mediums produced in the exemplary embodiments in the same manner as above at an accumulated light amount of 5.8 mJ/cm², except for changing the procedure, by first exposing blue laser light having the wavelength λ₁ of 473 nm with the blue laser 41B. When the post-recording transmission spectrum was measured, as shown in Table 3, the transmittance T_{2after} at λ₂=532 nm was 80.5%.

TABLE 3

| | Transmittance | | | |
|---|---|---|---|---|
| | | | Rate of | |
| | | 473 nm | Change ΔT | |
| | Before | After | (T_{after} − T)/ | Diffraction |
| | Recording | Exposure | T_{after} | Efficiency |
| λ₁ = 473 nm | T₁ = 6.3% | — | — | 65% |
| λ₂ = 532 nm | T₂ = 53.2% | T_{2after} = 80.5% | ΔT₂ = 33.1% | 53% |

Next, on the same position, recording exposure was carried out at an accumulated light amount of 3.8 mJ/cm² using a Nd:YAG laser emitting green light having the wavelength λ₂ of 532 nm, and then post-curing was carried out in the same manner as in the first exemplary embodiment. When the diffraction efficiency of the reflective hologram was determined based on the transmission spectrum from a spectrophotometer, as shown in Table 3, the diffraction efficiency was 65% at λ₁ and 53% at λ₂, thus showing a large difference. Further, both of these diffraction efficiencies were substantially less than the exemplary embodiments shown in Table 1.

This is because the recording was carried out in a state in which neither transmittance T₁ or T₂ at the wavelengths λ₁ or λ₂ was suitable. T₁ in the Comparative Example was very low, at 6.3%. When recording exposure was carried out in this state, the intensity ratio in the recording layer of the two light beams incident from either side of the photopolymer medium differed greatly due to the absorption of light in the recording layer. Consequently, the contrast of the formed interference fringe deteriorated, whereby it is thought that the diffraction efficiency at λ₁ deteriorated. On the other hand, T_{2after} was a high 80.5%, and the recording sensitivity at the wavelength λ₂ was very low. Consequently, the diffraction efficiency at λ₂ can also thought to have deteriorated.

The above exemplary embodiments used a sensitizing dye having a recording sensitivity to both green and blue light in a single layer recording layer 14. In this case, one type of sensitizing dye was practically used.

However, using practically one type of sensitizing dye means that in multiplexed recording with a plurality of wavelengths, when recording is carried out at one of those wavelengths not only does the absorbance at that wavelength attenuate, but the absorbance at the other wavelengths also attenuates at a fixed ratio or more. Therefore, as long as the characteristics are satisfied, other auxiliary dyes may also be included.

Further, in the exemplary embodiments, although a single recording layer 14 was first subjected to recording exposure by green laser light, and then subjected to recording exposure by blue laser light, as illustrated below, this order depends on the magnitude of transmittance T₁ and T₂.

The recording layer 14 is formed from a material in which, when the transmittance T₁ of light at the wavelength λ₁ and the transmittance T₂ of light at the wavelength λ₂ of the recording layer 14 before recording are both less than 80%, and T₁≠T₂ is satisfied, the transmittance T_{after} of light at the wavelength λ₂ or λ₁ after recording has been performed with light at only the wavelength λ₁ or λ₂ that has the higher transmittance is greater than the lower of the values from among T₁ and T₂, and the transmittance T_{after} is more than 10% and less than 80%.

More specifically, when T₁<T₂ is satisfied, recording is carried out first only with light at the wavelength λ₂, and then recording is carried out only with light at the wavelength λ₁, in which the transmittance T₁ of light at the wavelength λ₁ and the transmittance T₂ of light at the wavelength λ₂ of the recording layer 14 before recording are both less than 80%.

In this case, the recording layer material is selected from among materials in which the transmittance T_{1after} of light at the wavelength λ₁ after recording has been carried out with only light at the wavelength λ₂ satisfies T_{1after}>T₁, and 10%<T_{1after}<80%.

Further, here λ₂−λ₂≧20 nm is satisfied.

The reason why transmittance T₁ and transmittance T₂ are both less than 80% is because if the transmittance is 80% or more, a sufficient recording sensitivity cannot be obtained, and it is difficult to form an interference fringe.

Further, the reason why λ₂−λ₁≧20 nm is because if the difference between the two is less than 20 nm, it is difficult to discriminate between the two wavelengths, and the light in the two wavelength regions cannot be said to have a recording sensitivity. In addition, if the difference between the two is less than 20 nm, the two wavelengths cannot be visually distinguished, which makes it impossible to achieve the object of the present invention, which is to record a color hologram image.

Moreover, when T₁<T₂ is satisfied, it is desirable that ΔT₁=(T_{1after}−T₁)/T_{1after}>0.1 be satisfied.

This means that when ΔT=(T_{1after}−T₁)/T)_{after} is less than 0.1, the bleaching property of the used sensitizing dye is insufficient. Therefore, coloration from the sensitizing dye remains even after post curing is carried out after recording, so that a good color hologram image cannot be obtained. For the same reason, when T₁>T₂ is satisfied, it is desirable that ΔT₂=(T_{2after}−T₂)/T_{2after}>0.1 be satisfied.

When T₁>T₂ is satisfied, recording is carried out only with light at the wavelength λ₂, which has a higher transmittance, and then recording is carried out with light at the wavelength λ₂, which has a lower transmittance.

In this case, the recording layer material is selected from among materials in which the transmittance T_{2after} of light at the wavelength λ₂ after recording has been carried out with only light at the wavelength λ₁ satisfies T_{2after}>T₂, and 10%<T_{2after}<80%.

The reason for setting T_{1after} or T_{2after} to be greater than 10% in 10%<T_{1after}<80% or 10%<T_{2after}<80% is because when T_{1after}, or T_{2after} is 10% or less, it is difficult to form an interference fringe with the light having the wavelength of λ₂ or λ₁ with a uniform and good contrast in the depth direction of the recording layer.

Further, it is preferred to select the recording layer material from among materials which, when the wavelength of light having a pre-recording transmittance of Tₘ is λₘ, satisfy λ₁<λₘ<λ₂, Tₘ<T₁, and Tₘ<T₂.

In addition, it is preferred to select the sensitizing dye from among materials so that it is essentially one type as described above, and when the maximum absorption wavelength of the sensitizing dye in the recording material composition is λₘₐₓ, λ₁<λₘₐₓ<λ₂ is satisfied.

As the sensitizing dye that is preferably used in the recording layer according to the present invention, more specifically, it is preferred to use a dye that has a maximum absorption in the visible light region, an excellent sensitizing performance for the coexisting polymerization initiator, and good post-reaction bleaching property.

Specific examples of the sensitizing dye include a (thio)xanthene dye, a (keto)coumarin dye, a cyanine dye, a merocyanine dye, an anthraquinone dye, a squarylium dye, a thiopyrylium salt dye, and a porphyrin dye.

On the other hand, specific examples of the photopolymerization used together with the sensitizing dye include an organic peroxide, a benzophenone, a diphenyl iodonium salt, an iron arene complex, a titanocene, a bisimidazole initiator, an N-phenylglycine, and a tris(trichloromethyl)triazine derivative.

The reaction efficiency (sensitivity) of the initiation system composed of the photopolymerization initiator and the sensitizing dye and the bleaching property of the sensitizing dye depend on the combination of the photopolymerization initiator and the sensitizing dye. Therefore, a sensitizing dye that fits the required characteristics of the present invention may be selected as appropriate, based on the used photopolymerization initiator. Further, the sensitizing dye and the photopolymerization initiator preferably used in the present invention are not limited to the examples mentioned above.

When recording an actual image or information, recording exposure is carried out using condensed light or plane waves in which image information, binary page data and the like is superimposed. However, when such a modulated signal is recorded, the correct values for T_{1after} or T_{2after} may not be obtained.

To prevent this, in the exemplary embodiments according to the present invention, it is preferred to set T_{1after} or T_{2after} as values measured after interference exposure by two non-modulated plane waves. Alternatively, the transmittance after exposure by a single non-modulated plane wave (without forming an interference fringe) may be used for T_{1after} or T_{2after}. In this case, it is preferred to set the wavelength during exposure and the integral light amount so as to match the actual signal recording conditions.

What is claimed is:

1. A photopolymer medium for color hologram image recording, comprising a recording layer which comprises at least a photopolymerizable monomer, a photopolymerization initiator, and a sensitizing dye, and which has a recording sensitivity to light in two wavelength regions of a wavelength λ₁ and a wavelength λ₂, in which λ₂−λ₁≧20 nm is satisfied,
wherein the recording layer is formed from a material in which, when a transmittance T₁ of light at the wavelength λ₁ and a transmittance T₂ of light at the wavelength λ₂ of the recording layer before recording are both less than 80% and T₁≠T₂ is satisfied, a transmittance T_{after} of light at the wavelength λ₂ or λ₁ after recording has been performed with light at only the wavelength λ₁ or λ₂ having a higher transmittance is greater than a lower value from among T₁ and T₂, and the transmittance T_{after} is more than 10% and less than 80%.

2. The photopolymer medium for color hologram image recording according to claim 1, wherein the recording layer is formed from a material in which T₁<T₂ is satisfied, a transmittance T_{1after} of light at the wavelength λ₁ after recording has been carried out with only light at the wavelength λ₂ satisfies T_{1after}>T₁, and 10%<T_{1after}<80%.

3. The photopolymer medium for color hologram image recording according to claim 2, wherein T₁ and T_{1after} satisfy ΔT₁=(T_{1after}−T₁)/T_{1after}>0.1.

4. The photopolymer medium for color hologram image recording according to claim 1, wherein the recording layer is formed from a material in which T₁>T₂ is satisfied, a transmittance T_{2after} of light at the wavelength λ₂ after recording has been carried out with only light at the wavelength λ₁ satisfies T_{2after}>T₂, and 10%<T_{2after}<80%.

5. The photopolymer medium for color hologram image recording according to claim 4, wherein T₂ and T_{2after} satisfy ΔT₂=(T_{2after}−T₂)/T_{2after}>0.1.

6. The photopolymer medium for color hologram image recording according to claim 1, wherein λ₁ and λ₂ satisfy 440 nm≦λ₁≦490 nm and 510 nm≦λ₂≦535 nm, respectively.

7. The photopolymer medium for color hologram image recording according to claim 1, wherein, when the wavelength of light having a pre-recording transmittance of Tₘ is λₘ, the recording layer is formed from a material which satisfies λ₁<λₘ<λ₂, Tₘ<T₁, and Tₘ<T₂.

8. The photopolymer medium for color hologram image recording according to claim 1, wherein the recording layer includes one or two recording layers, the sensitizing dye in the one or two recording layers are essentially one type, and when the maximum absorption wavelength of the sensitizing dye in the recording material composition is λₘₐₓ, λ₁<λₘₐₓ<λ₂ is satisfied.

9. The photopolymer medium for color hologram image recording according to claim 1, comprising a second recording layer in addition to the recording layer, the second recording layer having a sensitivity to light at a wavelength λ₃ in which λ₃−λ₂≧20 nm is satisfied.

10. A method for recording a color hologram image which is formed from a plurality of colors on a photopolymer medium for color hologram image recording, the photopolymer medium comprising at least one recording layer which comprises at least a photopolymerizable monomer, a photopolymerization initiator, and a sensitizing dye, and which has a recording sensitivity to light in two wavelength regions of a wavelength λ₁ and a wavelength λ₂, in which λ₂−λ₁≧20 nm is satisfied, the method comprising:
when performing wavelength multiplexed recording using a light source having the wavelength λ₁ and a light source having the wavelength λ₂, respectively, if a transmittance of light at the wavelength λ₁ of the photopolymer medium before recording is T₁ and a transmittance of light at the wavelength λ₂ of the photopolymer medium is T₂, and T₁≠T₂ is satisfied, first performing recording with light at the wavelength λ₁ or λ₂ that has the higher transmittance so that the transmittance of light at λ₂ or λ₁ is greater than 10% and less than 80%, and then performing recording with light at the wavelength λ₂ or λ₁.

11. The method for recording a color hologram image according to claim 10, wherein, when T₁<T₂ is satisfied, recording with light at the wavelength λ₂ is performed first so that 10%<T₁<80% is satisfied, and then recording with light at the wavelength λ₁ is performed.

12. The method for recording a color hologram image according to claim 10, wherein, when T₁>T₂ is satisfied, recording with light at the wavelength λ₁ is performed first so that 10%<T₂<80% is satisfied, and then recording with light at the wavelength λ₂ is performed.

13. The method for recording a color hologram image according to claim 10, wherein the photopolymer medium comprises a second recording layer in addition to the recording layer formed from one layer, the second recording layer having a sensitivity to light at a wavelength λ₃ in which λ₃−λ₂≧20 nm is satisfied, and wherein recording is performed on the second recording layer with light at the wavelength λ₃ before performing the recording with light at the wavelengths λ₁ and λ₂.
